(19) United States
(12) Patent Application Publication
(10) Pub. No.: US 2026/0367981 A1
(43) Pub. Date: Nov. 19, 2026

(54) METHOD AND SYSTEM FOR AUTOMATING RESOURCE MANAGEMENT

(71) Applicant: JPMorgan Chase Bank, N.A., New York, NY (US)

(72) Inventor: Mona PAL, Mumbai (IN)

(73) Assignee: JPMorgan Chase Bank, N.A., New York, NY (US)

(21) Appl. No.: 19/257,273

(22) Filed: Jul. 1, 2025

(30) Foreign Application Priority Data
May 16, 2025 (IN) 202511047306

(51) Int. Cl. G06F 9/50

(52) U.S. Cl. CPC G06F 9/5038

(57) ABSTRACT

A method for automating resource management is disclosed. The method includes collecting a set of real-time data and a set of historical data. The method includes predicting workload demand and resource utilization in real-time based on the set of real-time data and the set of historical data. The method includes receiving a user input indicative of a user priority associated with one from among a cost optimization and a performance optimization. The method includes extracting multi-cloud flexibility data from a multi-cloud orchestration module. The method includes optimizing the predicted workload demand and the predicted resource utilization based on a combination of the user input and the multi-cloud flexibility data. Further, the method includes generating a plurality of scaling decisions based on optimizing the predicted workload demand and the predicted resource utilization and executing the plurality of scaling decisions.

### CROSS-REFERENCE TO RELATED APPLICATIONS

This application claims priority benefit from Indian Application No. 202511047306, filed on May 16, 2025, in the India Patent Office, which is hereby incorporated by reference in its entirety.

### FIELD OF THE DISCLOSURE

This technology generally relates to the field of cloud resource management, and more particularly relates to a method and a system for automating resource management in real-time in a multi-cloud environment.

### Background Information

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

In recent years, cloud computing has become the backbone of data processing and analytics. Businesses and organizations increasingly rely on cloud-based platforms to store, process, and analyze vast amounts of data. These platforms provide scalable computing resources that may be adjusted based on workload demand. However, traditional methods of resource scaling in cloud environments present significant challenges including manual scaling limitations, rule-based auto-scaling inefficiencies, cost vs. performance trade-off, and multi-cloud complexity. Many organizations rely on manual scaling which includes manual provisioning of cloud resources, where IT administrators predict workload requirements and allocate resources accordingly. This approach is inefficient, as it often leads to over-provisioning (wasting money on unused resources) or under-provisioning (causing slow performance and failures during peak demand). Further, some cloud providers offer rule-based auto-scaling, where resources are increased or decreased based on pre-set thresholds (e.g., CPU usage>80%). However, rule-based auto-scaling systems are reactive rather than predictive, thereby leading to delays in scaling decisions and inefficient resource utilization.

Furthermore, many organizations use multiple cloud providers, for example, Amazon Web Services (AWS)®, Microsoft Azure® (‘Azure’), Google Cloud Platform (GCP)® and the like, to optimize cost and performance. However, managing resources across multiple cloud providers manually or using rule-based approaches is complex and inefficient.

Hence, in view of these limitations, there arises an imperative need to provide an efficient solution to overcome the above-mentioned limitations and to provide a method and a system for automating resource management.

### SUMMARY

The present disclosure, through one or more of its various aspects, embodiments, and/or specific features or sub-components, provides, among others, various systems, servers, devices, methods, media, programs, and platforms to generate recommendations for execution of computing applications over a simulation framework.

According to an aspect of the present disclosure, a method for automating resource management is disclosed. The method is being implemented by at least one processor. The method includes collecting, by the at least one processor, a set of real-time data and a set of historical data from a plurality of sources. The method includes predicting, by the at least one processor, workload demand and resource utilization in real-time based on the collected set of real-time data and the set of historical data. The method further includes receiving, by the at least one processor, a user input. The user input is indicative of at least a user priority associated with at least one from among a cost optimization and a performance optimization. The method further includes extracting, by the at least one processor, multi-cloud flexibility data from a multi-cloud orchestration module. Also, the method includes optimizing, by the at least one processor, the predicted workload demand and the predicted resource utilization based on a combination of at least the user input and the multi-cloud flexibility data. Thereafter, the method includes generating, by the at least one processor, a plurality of scaling decisions based on optimizing the predicted workload demand and the predicted resource utilization and further includes executing, by the at least one processor, the plurality of scaling decisions, where the plurality of scaling decisions are associated with the resource management.

In accordance with an exemplary embodiment, the set of real-time data and the set of historical data may be associated with workload metrics. The workload metrics may include metrics associated with at least one from among a CPU utilization, a memory utilization, input or output operations, a network bandwidth and a plurality of workload types.

In accordance with an exemplary embodiment, to predict the workload demand and the resource utilization, the method comprises analyzing, by the at least one processor, using a machine learning model, the set of real-time data and the set of historical data, and adapting, by the at least one processor, using the machine learning model, to dynamic changes in the set of real-time data, and the set of historical data through the facilitation of reinforcement learning technique.

In accordance with an exemplary embodiment, the plurality of scaling decisions may include at least one from among provisioning, resizing, and de-provisioning of a plurality of resources across a plurality of cloud providers.

In accordance with an exemplary embodiment, the method may include displaying at least: the workload metrics, the predicted workload demand, the predicted resource utilization, and the plurality of scaling decisions to the user.

In accordance with an exemplary embodiment, the method includes receiving a user feedback associated with the plurality of scaling decisions to refine the machine learning model.

In accordance with an exemplary embodiment, the multi-cloud flexibility data may comprise at least one from among cloud resource availability data, cost and pricing data, performance and latency data, and workload distribution data.

In accordance with an exemplary embodiment, the plurality of data sources may include at least one from among cloud infrastructure monitoring sources, and workload and job execution logs.

According to another aspect of the present disclosure, a computing device configured to implement a method for automating resource management is disclosed. The computing device includes a processor; a memory storing instructions; and a communication interface coupled to each of the processor and the memory. The processor may be programmed to cooperate with the instructions to perform operations including: collecting a set of real-time data and a set of historical data from a plurality of sources; predicting workload demand and resource utilization in real-time based on the collected set of real-time data and the set of historical data; receiving a user input, wherein the user input is indicative of at least a user priority associated with at least one from among a cost optimization and a performance optimization; extracting multi-cloud flexibility data from a multi-cloud orchestration module; optimizing the predicted workload demand and the predicted resource utilization based on a combination of at least the user input and the multi-cloud flexibility data; generating a plurality of scaling decisions based on optimizing the predicted workload demand and the predicted resource utilization; and executing the plurality of scaling decisions, where the plurality of scaling decisions are associated with the resource management.

In accordance with an exemplary embodiment, the set of real-time data and the set of historical data may be associated with workload metrics. The workload metrics may include metrics associated with at least one from among a CPU utilization, a memory utilization, input or output operations, a network bandwidth and a plurality of workload types.

In accordance with an exemplary embodiment, to predict the workload demand and the resource utilization, the operations may further include analyzing, using a machine learning model, the set of real-time data and the set of historical data, and adapting, using the machine learning model, to dynamic changes in the set of real-time data, and the set of historical data through the facilitation of reinforcement learning technique.

In accordance with an exemplary embodiment, the plurality of scaling decisions may include at least one from among provisioning, resizing, and de-provisioning of a plurality of resources across a plurality of cloud providers.

In accordance with an exemplary embodiment, the operations may further include displaying at least one from among: the workload metrics, the predicted workload demand, the predicted resource utilization, and the plurality of scaling decisions to the user.

In accordance with an exemplary embodiment, the operations may further include receiving a user feedback associated with the plurality of scaling decisions to refine the machine learning model.

In accordance with an exemplary embodiment, the multi-cloud flexibility data may include at least one from among cloud resource availability data, cost and pricing data, performance and latency data, and workload distribution data.

In accordance with an exemplary embodiment, the plurality of data sources may include at least one from among cloud infrastructure monitoring sources, and workload and job execution logs.

According to yet another aspect of the present disclosure, a non-transitory computer-readable storage medium storing instructions for automating resource management is disclosed. The instructions include executable code which, when executed by a processor, may cause the processor to perform operations comprising collecting a set of real-time data, and a set of historical data from a plurality of data sources; predicting workload demand and resource utilization in real-time based on the collected set of real-time data and the set of historical data; receiving a user input, wherein the user input is indicative of at least a user priority associated with at least one from among a cost optimization and a performance optimization; extracting multi-cloud flexibility data from a multi-cloud orchestration module; optimizing the predicted workload demand and the predicted resource utilization based on a combination of at least the user input and the multi-cloud flexibility data; generating a plurality of scaling decisions based on optimizing the predicted workload demand and the predicted resource utilization; and executing the plurality of scaling decisions, wherein the plurality of scaling decisions are associated with resource management.

In accordance with an exemplary embodiment, the set of real-time data and the set of historical data may be associated with workload metrics. The workload metrics may include metrics associated with at least at least one from among a CPU utilization, a memory utilization, input or output operations, a network bandwidth and a plurality of workload types.

In accordance with an exemplary embodiment, to predict the workload demand and the resource utilization, the processor may perform operations including analyzing, using a machine learning model, the set of real-time data and the set of historical data, and adapting, using the machine learning model, to dynamic changes in the set of real-time data, and the set of historical data through the facilitation of reinforcement learning technique.

In accordance with an exemplary embodiment, the plurality of scaling decisions may include at least one from among provisioning, resizing, and de-provisioning of a plurality of resources across a plurality of cloud providers.

In accordance with an exemplary embodiment, the processor may perform operations including displaying at least one from among the workload metrics, the predicted workload demand, the predicted resource utilization, and the plurality of scaling decisions to the user.

In accordance with an exemplary embodiment, the processor may perform operations including receiving a user feedback associated with the plurality of scaling decisions to refine the machine learning model.

In accordance with an exemplary embodiment, the multi-cloud flexibility data may include at least one from among cloud resource availability data, cost and pricing data, performance and latency data, and workload distribution data.

In accordance with an exemplary embodiment, the plurality of data sources may include at least one from among cloud infrastructure monitoring sources, and workload and job execution logs.

### BRIEF DESCRIPTION OF THE DRAWINGS

The present disclosure is further described in the detailed description which follows, about the noted plurality of drawings, by way of non-limiting examples of exemplary embodiments of the present disclosure, in which like characters represent like elements throughout the several views of the drawings.

FIG. 1 illustrates an exemplary computer system for automating resource management, in accordance with an exemplary embodiment of the present disclosure.

FIG. 2 illustrates an exemplary diagram of a network environment for automating resource management, in accordance with an exemplary embodiment of the present disclosure.

FIG. 3 illustrates an exemplary system for automating resource management, in accordance with an exemplary embodiment of the present disclosure.

FIG. 4 illustrates a process flow of an exemplary system for automating resource management, in accordance with an exemplary embodiment of the present disclosure.

FIG. 5 illustrates an exemplary method flow diagram for automating resource management, in accordance with an exemplary embodiment of the present disclosure.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

As mentioned earlier, traditional methods of resource scaling in cloud environments present significant challenges including manual scaling limitations, rule-based auto-scaling inefficiencies, cost vs. performance trade-off, and multi-cloud complexity. For example, organizations that leverage Databricks® clusters for big data processing and machine learning workloads often face challenges in optimizing resource usage to balance performance and cost. Current cluster auto-scaling mechanisms, though useful, are typically reactive and limited to basic triggers like CPU or memory utilization. These mechanisms fail to account for the complexity of workload variations, patterns, or long-term optimization goals, such as balancing cost efficiency with performance. As a result, users frequently encounter issues such as over-provisioning (leading to increased costs) or under-provisioning (leading to degraded performance).

For example, distributing large volumes of data is a key challenge for computing and information systems of any appreciable scale. The exemplary embodiments as disclosed herein apply to a vast spectrum of applications that would benefit from low-latency delivery of large volumes of data to multiple data consumers. These embodiments fundamentally address the practical problems of distributing such data over bandwidth-limited communication channels to compute-limited data consumers. This problem is particularly acute in connection with real-time data. Real-time data distribution systems must contend with these physical limits when the real-time data rates exceed the ability of the communication channel to transfer the data and/or the ability of the data consumers to consume the data. Furthermore, the distribution of real-time financial market data to applications such as trading, risk monitoring, order routing, and matching engines represents one of the most demanding contemporary use cases. While many of the exemplary embodiments discussed herein focus on applications in the financial markets, it should be understood that the technology described herein may be applied to a wide variety of other application domains.

Against this background, it is desirable for new technology to further reduce latency, increase scale (wide distribution), and reduce the utilization of compute resources (so these computer resources can be freed for devotion to other tasks).

Exemplary embodiments as disclosed herein may include mechanisms that provide for the construction of real-time data distribution systems that meet any or all of following goals, or any combination thereof: reduced data latency; scalability for large numbers of data consumers; reduced power consumption; reduced space consumption; reduced management complexity and cost; well-defined component interfaces; independent deployment of components, etc., but the disclosure is not limited thereto.

For example, to address the limitations of conventional methods and systems mentioned above, the exemplary embodiments as disclosed herein may implement artificial intelligence powered system that may: predict workload demand in real-time based on historical usage patterns and job types; dynamically adjust not only the size of the cluster but also the type of instances and configurations, tailoring them to specific workload characteristics; provide cost-performance optimization by allowing users to specify their priorities (e.g., cost savings vs. high performance) and adjusting resource allocation accordingly; leverage intelligent management of spot and on-demand instances to minimize costs while maintaining performance, etc., but the disclosure is not limited thereto.

Unlike traditional auto-scaling, which typically adjusts only the number of nodes, the AI-driven system as disclosed herein may be configured to adjust both the cluster size and instance type based on the specific workload requirements (e.g., compute-heavy, memory-intensive, or I/O bound tasks). This may result in a more optimized allocation of resources, ensuring that each job is executed on the most suitable infrastructure, thereby improving both performance and cost efficiency.

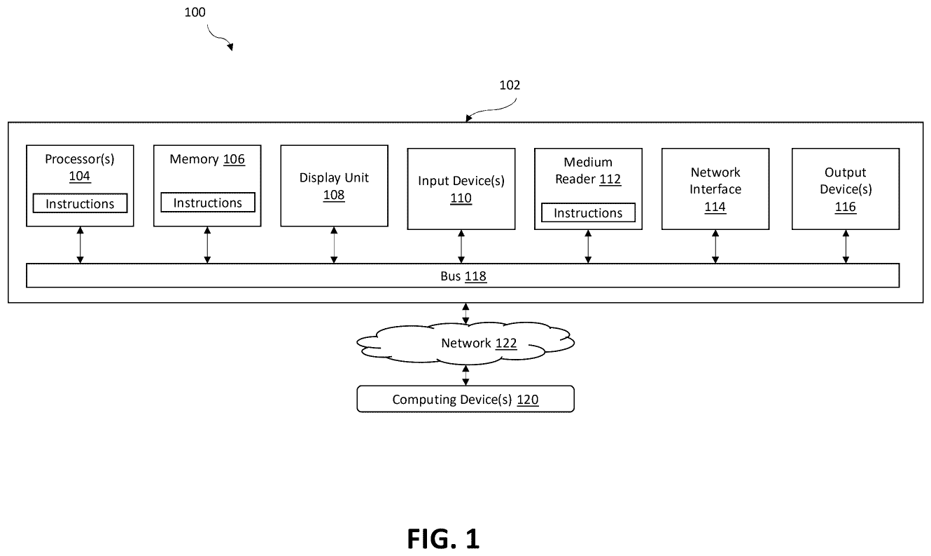

FIG. 1 is an exemplary system 100 for use in accordance with the embodiments described herein. The system 100 is generally shown and may include a computer system 102 which is generally indicated. The term “computer system” may also be referred to as “computing device” and such phrases/terms can be used interchangeably in the specifications.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud-based environment. Even further, the instructions may be operative in such cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art will appreciate that various embodiments of the computer system 102 may include multiple input devices 110. Moreover, those skilled in the art will further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor 104, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as but not limited to, a network interface 114 and an output device 116. The output device 116 may include but is not limited to, a speaker, an audio out, a video out, a remote-controlled output, a printer, or any combination thereof. Additionally, the term “Network interface” may also be referred to as “Communication interface” and such phrases/terms can be used interchangeably in the specifications.

Each of the components of the computer system 102 may be interconnected and communicate via a bus 118 or other communication link. As shown in FIG. 1, the components may each be interconnected and communicate via an internal bus. However, those skilled in the art will appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computing devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art will appreciate that additional networks 122 which are known and understood may additionally or alternatively be used and that the exemplary networks 122 are not limiting or exhaustive. Also, while the network 122 is shown in FIG. 1 as a wireless network, those skilled in the art will appreciate that the network 122 may also be a wired network.

The additional computing device 120 is shown in FIG. 1 as a personal computer. However, those skilled in the art will appreciate that, in alternative embodiments of the present application, the computing device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art will appreciate that the above-listed devices are merely exemplary devices and that the computing device 120 may be any additional device or apparatus commonly known and understood in the art without departing from the scope of the present application. For example, the computing device 120 may be the same or similar to the computer system 102. Furthermore, those skilled in the art similarly understand that the device may be any combination of devices and apparatuses.

Those skilled in the art will appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor 104 described herein may be used to support a virtual processing environment.

As described herein, various embodiments provide methods and systems for automating resource management.

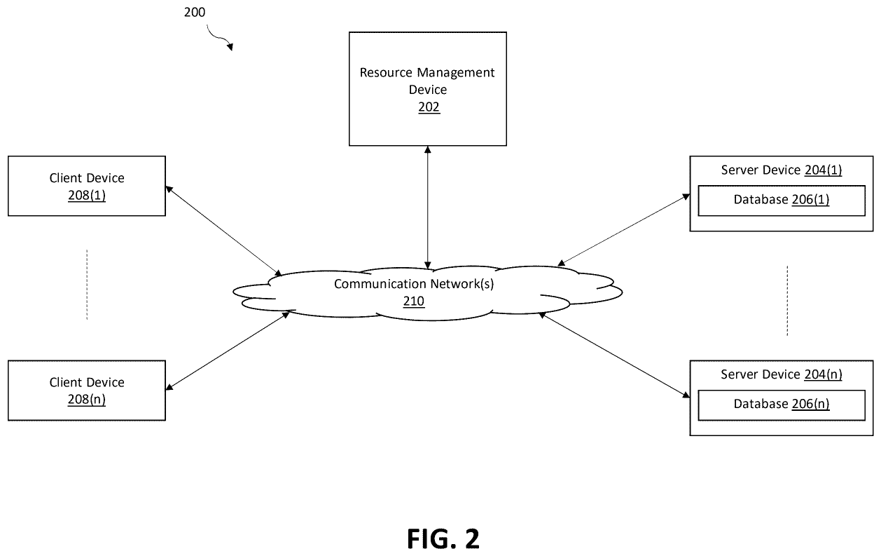

Referring to FIG. 2, a schematic diagram of an exemplary network environment 200 for automating resource management is illustrated. In an exemplary embodiment, the method is executable on any networked computer platform, such as, for example, a personal computer (PC).

The method for automating resource management may be executed by a resource management device 202. The resource management device 202 may be the same or similar to the computer system 102 as described with respect to FIG. 1. The resource management device 202 may store one or more applications that may include executable instructions that, when executed by the resource management device 202, cause the resource management device 202 to perform desired actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the resource management device 202 itself, may be located in the virtual server(s) running in a cloud-based computing environment rather than being tied to one or more specific physical network computing devices. Also, the application(s) may be running in one or more virtual machines (VMs) executing on the resource management device 202. Additionally, in one or more embodiments of this technology, virtual machine(s) running on the resource management device 202 may be managed or supervised by a hypervisor.

In the network environment 200 of FIG. 2, the resource management device 202 is coupled to a plurality of server devices 204(1)-204(n) that hosts a plurality of databases 206(1)-206(n), and also to a plurality of client devices 208(1)-208(n) via communication network(s) 210. A communication interface of the resource management device 202, such as the network interface 114 of the computer system 102 of FIG. 1, operatively couples and communicates between the resource management device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the resource management device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and resource management device that efficiently implement the method for automating resource management.

By way of example only, the communication network(s) 210 may include local area network(s) (LAN(s)) or wide area network(s) (WAN(s)) and can use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), public switched telephone networks (PSTNs), ethernet-based packet data networks (PDNs), combinations thereof, and the like.

The resource management device 202 may be a standalone device or integrated with one or more other devices or apparatuses, such as one or more of the server devices 204(1)-204(n), for example. In one particular example, the resource management device 202 may include or be hosted by one of the server devices 204(1)-204(n), and other arrangements are also possible. Moreover, one or more of the devices of the resource management device 202 may be in a same or a different communication network including one or more public, private, or cloud-based networks, for example.

The plurality of server devices 204(1)-204(n) may be the same or similar to the computer system 102 or the computing device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the resource management device 202 via the communication network(s) 210 according to the hypertext transfer protocol (HTTP)-based and/or javascript object notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases or repositories 206(1)-206(n) that are configured to store data related to a plurality of recommendations and a plurality of metrics related to at least one task code file.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computing device 120 as described with respect to FIG. 1, including any features or combination of features described with respect thereto. For example, the client devices 208(1)-208(n) in this example may include any type of computing device that can interact with the resource management device 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary embodiment, at least one client device 208 is a wireless mobile communication device, e.g., a smartphone.

The client devices 208(1)-208(n) may run interface applications, such as standard web browsers or standalone client applications, which may provide an interface to communicate with the resource management device 202 via the communication network(s) 210 in order to communicate user requests and information. The client devices 208(1)-208(n) may further include, among other features, a display device, such as a display unit or touchscreen, and/or an input device, such as a keyboard, for example.

Although the exemplary network environment 200 with the resource management device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the resource management device 202, the server devices 204(1)-204(n), or the client devices 208(1)-208(n), for example, may be configured to operate as virtual instances on the same physical machine. In other words, one or more of the resource management devices 202, the server devices 204(1)-204(n), or the client devices 208(1)-208(n) may operate on the same physical device rather than as separate devices communicating through communication network(s) 210. Additionally, there may be more or fewer resource management devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, packet data networks (PDNs), the Internet, intranets, and combinations thereof.

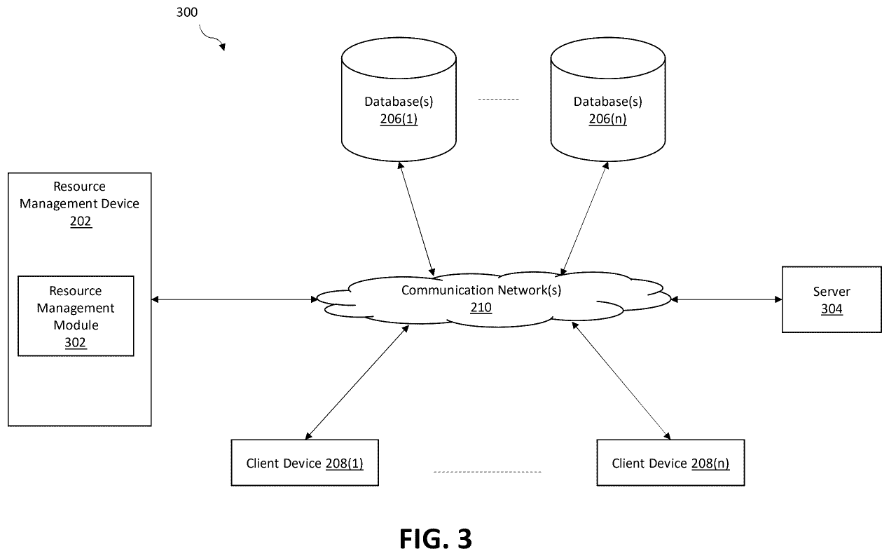

FIG. 3 illustrates an exemplary system for automating resource management, in accordance with an exemplary embodiment. As illustrated in FIG. 3, according to exemplary embodiments, the system 300 may include a resource management device 202 within which a resource management module 302 is embedded, a server 304, a database(s) 206(1) . . . 206(n), a plurality of client devices 208 (1) . . . 208(n) connected via a communication network 210, but the disclosure is not limited thereto.

The resource management device 202 as described and shown in FIG. 3 includes the resource management module 302, although it may include other units, modules, databases, or applications, for example. As will be described below, the resource management module 302 is configured to carry out a method for automating resource management.

An exemplary system 300 for enabling a mechanism for automating resource management by utilizing the network environment of FIG. 2 is shown as being executed in FIG. 3. Specifically, the first client device 208(1) and a second client device 208(2) are illustrated as being in communication with the resource management device 202. In this regard, the first client device 208(1) and the second client device 208(2) may be “clients” of the resource management device 202 and are described herein as such. Nevertheless, it is to be known and understood that the first client device 208(1) and/or the second client device 208(2) need not necessarily be “clients” of the resource management device 202, or any entity described in association therewith herein. Any additional or alternative relationship may exist between either or both of the first client device 208(1) and the second client device 208(2) and the resource management device 202, or no relationship may exist.

Further, the resource management device 202 is illustrated as being able to access one or more repositories 206(1) . . . 206(n). The resource management module 302 may be configured to access these repositories/databases to provide a method for automating resource management. In some embodiments, the server 304 may be the same or equivalent to the server device 204 as illustrated in FIG. 2.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the resource management device 202 via broadband or cellular communication. These embodiments are merely exemplary and are not limiting or exhaustive.

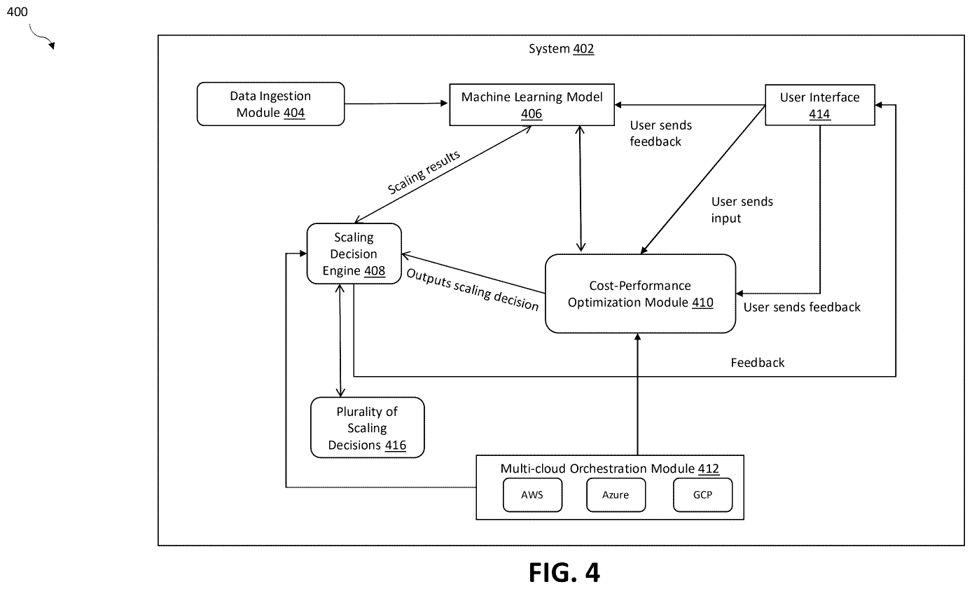

FIG. 4 illustrates a process flow 400 of an exemplary system 402 for automating resource management, in accordance with an exemplary embodiment of the present disclosure. The system 402 includes a data ingestion module 404, a machine learning model 406, a scaling decision engine 408, a cost-performance optimization module 410, a multi-cloud orchestration module 412, and a user interface 414.

The data ingestion module 404 collects a set of real-time data and a set of historical data from a plurality of sources. The set of real-time data and the set of historical data may be associated with workload metrics. The workload metrics may include metrics associated with at least one from among a CPU utilization, a memory utilization, input or output operations, a network bandwidth and a plurality of workload types. The plurality of data sources may include at least one from among: cloud infrastructure monitoring sources, and workload and job execution logs. The cloud infrastructure monitoring sources may monitor cloud resource utilization and performance in real time. In an exemplary implementation, the cloud infrastructure monitoring sources may include AWS CloudWatch®, Microsoft Azure Monitor®, Google Cloud Stackdriver®, and the like. For example, the AWS CloudWatch® tracks CPU utilization, memory usage, and network activity. Further, the Microsoft Azure Monitor® may monitor health of Azure virtual machines. The Google Cloud Stackdriver® may provide logs, metrics, and traces for cloud services.

Further, in an exemplary implementation, workload and job execution logs may include Databricks® logs that record Spark® job execution time and memory consumption, and Apache Hadoop YARN® (Yet Another Resource Negotiator) logs that may monitor big data job scheduling and failures. In an exemplary embodiment, the data ingestion module 402 may monitor cloud infrastructure parameters, workload execution logs and job performance statistics. For example, let's consider a data analytics company that processes large-scale datasets using Databricks clusters on a multi-cloud infrastructure. The system 402 may utilize the data ingestion module 404 to collect real-time metrics like CPU utilization (e.g., 70%), memory utilization (e.g., 84%), and input-output bandwidth e.g. (5 GB/s). The set of historical data may include historical periodic data, for example, every Monday at 10 AM, workload spikes by 60% due to weekly report generation.

The data ingestion module 404 may pre-process and normalize the collected set of real-time data and the set of historical data for further analysis by the machine learning model 406 (herein after, ML model 406). In an exemplary embodiment, the data ingestion module 404 may collect the set of real-time data and the set of historical data from multiple cloud providers and workload sources. In an exemplary implementation, an e-commerce website with dynamic traffic may collect the set of real-time data, including but not limited to, such as CPU, memory utilization, input-output operation metrics from AWS EC2® instances. The AWS EC2® refers to Amazon Elastic Compute Cloud® which is a cloud computing service that provides scalable virtual servers called instances. These instances allow users to run applications without the need of physical hardware, enabling on-demand computing power. For example, a video streaming platform may host its backend services on AWS EC2®. During peak hours, AWS EC2® instances scale up to handle traffic spikes, and unused instances are terminated to save costs.

The data ingestion module 404 may be associated with the ML model 406. The set of real-time data and the set of historical data may be sent to the ML model 406 for predicting workload demand and resource utilization in real-time. In an exemplary embodiment, the resource utilization may refer to cloud resource utilization. The ML model 406 may use reinforcement learning technique to perform the prediction. To predict the workload demand and the resource utilization, the ML model 406 may be configured to analyze the set of real-time data and the set of historical data and adapt to dynamic changes in the set of real-time data, and the set of historical data through the facilitation of the reinforcement learning technique. The reinforcement learning technique may allow the ML model 406 to learn over time and improve prediction by continuously interacting with the set of real-time data and the set of historical data. In an exemplary implementation, the ML model 406 may analyze past spikes in traffic on an e-commerce platform during Black Friday sales. Based on this analysis, the ML model 406 may predict that the workload may increase by 100% on an upcoming sale day. The ML model 406, based on the prediction, may generate scaling results, such as “scaling up computing resources before the peak hours to prevent service disruptions”. In addition, the ML model 406 may also predict that certain instances are underutilized, and based on the prediction, the ML model 406 may recommend de-provisioning of the instances to reduce costs.

In an exemplary embodiment, the ML model 406 may be trained using the set of real-time data and the set of historical data collected by the data ingestion module 404. The set of real-time data and the set of historical data may act as training data. To ensure consistency, the collected data (set of real-time data and set of historical data) may undergo cleaning and normalization, aligning a plurality of cloud providers metrics into a common format. Once the collected data is processed, feature engineering may be performed to identify patterns and correlations. The system 402 may extract key workload characteristics such as time-based workload variations, resource consumption trends, and user-defined priorities for cost versus performance optimization. In an exemplary implementation, the key workload characteristics may help the ML model 406 understand dependencies between workload demands and cloud resource utilization, thereby improving its predictive capabilities.

Further, the scaling results, the predicted workload demand and the predicted resource utilization may be sent to the scaling decision engine 408 and the cost-performance optimization module 410. The cost-performance optimization module 410 may be associated with the scaling decision engine 408, the user interface 414 and the multi-cloud orchestration module 412. The cost-performance optimization module 410 may receive user input from a plurality of users through the user interface 414. The user input is indicative of at least a user priority associated with one from among a cost optimization and a performance optimization.

The cost-performance optimization module 410 may be configured to extract multi-cloud flexibility data from the multi-cloud orchestration module 412. The cost-performance optimization module 410 may optimize the predicted workload demand and the predicted resource utilization based on a combination of at least the user input and the multi-cloud flexibility data. The multi-cloud flexibility data may include at least one from among cloud resource availability data, cost and pricing data, performance and latency data, and workload distribution data.

In an exemplary implementation, the multi-cloud orchestration module 412 may extract cloud-specific data from a plurality of cloud providers like AWS®, Microsoft Azure®, and Google Cloud Platform® (GCP) to ensure workload distribution based on availability, latency, and cost factors. For example, a financial company may operate a real-time stock trading platform that processes a plurality of transactions per second. The financial company may utilize the multi-cloud orchestration module 412 to ensure low latency. The multi-cloud orchestration module 412 may monitor cloud resource availability, cost, and performance across AWS®, GCP®, and Microsoft Azure®. In an example, the multi-cloud orchestration module 412 may detect that the first cloud provider servers (e.g., AWS® servers) in the New York region have the lowest latency (5 ms) but are currently operating at full capacity during peak trading hours. The second cloud provider servers (eg., Microsoft Azure® servers) in London are available but have higher latency (15 ms) for US-based transactions. The third cloud provider servers (eg., GCP® servers) in the Chicago region offer a 20% lower cost and acceptable latency (7 ms). In an exemplary implementation, the multi-cloud orchestration module 412 may detect the high AWS® server usage and may identify GCP® servers as a cost-effective alternative. The workload may be dynamically shifted to GCP® servers for non-urgent transactions while keeping latency-sensitive trades on AWS® servers. By dynamically shifting to GCP® servers for non-urgent transactions, the multi-cloud orchestration module 412 may optimize workload distribution for both latency-sensitive tasks and cost-effective resource allocation.

The cost-performance optimization module 410 may send the optimized data (optimized predicted workload demand and optimized predicted resource utilization) to the scaling decision engine 408. The scaling decision engine 408 is configured to generate the plurality of scaling decisions 416 based on optimizing the predicted workload demand and the predicted resource utilization.

The cost-performance optimization module 410 balances cost and performance factors. The cost-performance optimization module 410 may evaluate the plurality of cloud providers (e.g., AWS®, Microsoft Azure®, GCP®) and compare instance costs, performance, and availability. In addition, the cost-performance optimization module 410 may analyze latency, processing power, and operational costs to determine the most optimal resource allocation. In an exemplary implementation, if cost-saving is prioritized, the cost-performance optimization module 410 may suggest migrating workloads to a lower-cost cloud provider or using spot instances. In another example, if performance is prioritized, the cost-performance optimization module 410 may allocate more powerful virtual machines (VMs) with higher CPU and memory configurations to reduce latency and improve throughput. The cost-performance optimization module 410 outputs feedback associated with the plurality of scaling decisions 416. The feedback may be sent to the scaling decision engine 408 and the machine learning model 406 (to refine the ML model 406).

For training the ML model 406, a combination of supervised learning models and reinforcement learning models may be employed. In an exemplary implementation, supervised learning models, including but not limited to, such as LSTMs (Long Short-Term Memory networks), Random Forests, and XGBoost, are trained using the set of historical data to forecast future workload demand. The training dataset may include past workload metrics and corresponding scaling decisions, while the model validation process ensures its accuracy before deployment. Additionally, the reinforcement learning technique may be utilized by the ML model 406 to continuously refine its decision-making process by learning from the feedback provided by the cost-performance optimization module 410 (as explained below). This allows the ML model 406 to dynamically adjust predictions during real-time workload fluctuations.

In an exemplary implementation, the ML model 406 may be trained using a plurality of steps. First, the set of historical data may be loaded and split into training and validation sets. The ML model 406 may be trained to recognize workload demand patterns and predict scaling needs in advance. Hyperparameters, such as learning rates and batch sizes, may be optimized using techniques like grid search and Bayesian optimization. The trained ML model 406 may then be validated against unseen workload scenarios to ensure its reliability before being deployed for real-time predictions.

To enhance accuracy over time, the ML model 406 may leverage continuous learning by integrating feedback from the scaling decision engine 408. If an executed scaling decision, such as provisioning or de-provisioning virtual machines, results in inefficiencies, the ML model 406 may adapt by adjusting its future predictions.

In an exemplary implementation, in a financial services company, the system 402 may detect that trade settlement workloads experience a 60% CPU spike at 4 PM EST due to market closing activities. Based on the historical data, the ML model may predict this demand surge and instructs the scaling decision engine 408 to provision additional AWS EC2® instances five minutes before the expected peak. If the actual demand is lower than anticipated, the reinforcement learning updates the model to refine future predictions, optimizing both cost and performance.

By continuously learning from the set of real-time data and refining its decision-making process, the ML model 406 may ensure efficient resource management across multiple cloud platforms.

The scaling decision engine 408 may further execute the plurality of scaling decisions based on the feedback. The plurality of scaling decisions 416 are associated with resource management. In an exemplary embodiment, the plurality of scaling decisions may include at least one from among provisioning, resizing, and de-provisioning of a plurality of resources across the plurality of cloud providers. In an exemplary embodiment, the plurality of resources may include compute resources such as virtual machines, containers, and serverless computing units that process workloads.

Compute resources are responsible for executing applications, computations, and data processing tasks. In an exemplary implementation, the plurality of resources may include storage resources such as block storage, object storage, databases, data warehouses and the like. The block storage may include, but is not limited to, AWS Elastic Block Store (EBS)®, and Microsoft Azure Managed Disks®. The object storage may include, but is not limited to, AWS Simple Storage Service (S3)®, Google cloud storage®, Microsoft Azure blob storage®. The databases may include, but are not limited to, Google Cloud SQL®, Snowflake®, Amazon RDS®. In yet another embodiment, the plurality of resources may include network resources such as load balancers, content delivery networks, interconnect services, virtual private cloud and virtual private networks.

In an exemplary implementation, the scaling decision engine 408 may interpret the predicted workload demand and the predicted resource utilization (machine learning model predictions) and the feedback outputted by the cost-performance optimization module 410 to generate the plurality of scaling decisions. In an embodiment, the plurality of scaling decisions 416 may be fed back into the machine learning model 406, via the user interface 414, to improve future predictions. The user interface 414 may display the workload metrics, the predicted workload demand and resource utilization and the plurality of scaling decisions to the user. Further, the user interface 414 may allow users to prioritize cost efficiency and performance. Also, the user interface 414 may receive a user feedback associated with the plurality of scaling decisions to refine the ML model 406.

In an exemplary implementation, a financial trading company running real-time algorithmic trading and risk analysis across AWS®, Microsoft Azure®, and GCP® experiences a 30% spike in trading requests as the stock market opens, due to sudden market volatility. The ML model 406 may predict this demand surge based on the set of historical data. In addition, the user input prioritizes performance over cost. The scaling decision engine 408 may execute the plurality of scaling decisions 416 by provisioning additional AWS EC2® and GCP® Compute Engine instances in low-latency regions to ensure uninterrupted trade execution. Simultaneously, the scaling decision engine 408 may resize existing Azure instances to handle real-time risk analysis computations. Once the market stabilizes, the scaling decision engine 408 may automatically de-provision extra instances to reduce cloud costs while retaining minimal standby resources for unexpected fluctuations. This automated scaling process ensures high-performance trading execution without unnecessary cloud expenses.

In an exemplary embodiment, the scaling decision engine 408 may be responsible for converting predictions of the ML model 406 into the plurality of scaling decisions 416. The scaling decision engine 408 may ensure that cloud resources are provisioned, resized, and de-provisioned dynamically based on the predicted workload demand while considering cost and performance trade-offs (received from the cost-performance optimization module 410). In an example, the ML model 406 may analyze the set of real-time data and the set of historical data and predicts the workload demand (spikes or reductions in demand). The ML model 406 may send predictions to the scaling decision engine 408, which determines the best scaling decision.

In an exemplary implementation, if an increase in workload demand is predicted, the scaling decision engine 408 may identify the optimal cloud provider and instance type (such as from AWS®, Microsoft Azure®, GCP® and the like), determine the best node configuration (e.g., CPU, memory, disk, GPU) and trigger a scale-up event by provisioning additional resources before the demand spike occurs. For example, a financial company runs real-time credit card fraud detection on a Databricks® cluster. If the ML model 406 detects a spike in transactions at the end of the month, the scaling decision engine 408 may preemptively add nodes to handle the extra load before transaction processing slows down. Further, if a workload is completed earlier than expected the scaling decision engine 408 may detect underutilized resources and may trigger a scale-down event by de-provisioning excess nodes. For example, a stock trading firm processes large batches of historical data for predictive analytics. If the job is completed ahead of schedule, the scaling decision engine 408 may automatically scale down the unused computing resources to avoid unnecessary cloud costs.

Further, the cost-performance optimization module 410 may adjust the plurality of scaling decisions 416 based on the user input. If the user input is associated with prioritizing the cost optimization, the cost-performance optimization module 410 may choose cheaper spot instances or smaller instance types. If performance is prioritized, the cost-performance optimization module 410 may allocate high-performance virtual machines with lower latency and more memory. In general, virtual machines (VMs) may be provisioned or de-provisioned dynamically to meet the workload demand. For example, during stock market hours, more VMs are provisioned to handle increased trade volumes. At night, unused VMs are de-provisioned to reduce cloud costs.

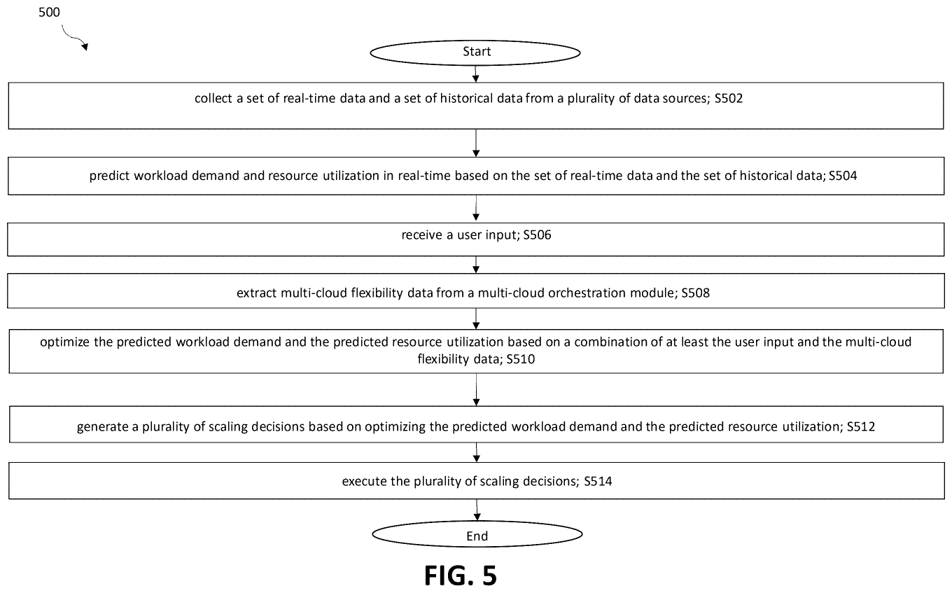

Referring to FIG. 5, an exemplary method 500 is shown for automating resource management, in accordance with an exemplary embodiment. In particular, the exemplary method 500 is shown for automating resource management.

As shown in FIG. 5, the method 500 begins following a need for automating resource management. The method 500 may be implemented by at least one processor 104. In an exemplary implementation, the method 500 may be performed by an exemplary system (herein after system) that may be a computing device 120 of FIG. 1.

At step S502, the method 500 includes collecting a set of real-time data and a set of historical data from a plurality of data sources. The set of real-time data and the set of historical data may be associated with workload metrics. The workload metrics may include metrics associated with at least one from among a CPU memory utilization, input or output operations, a network bandwidth and a plurality of workload types. In addition, the plurality of data sources may include at least one from among cloud infrastructure monitoring sources, and workload and job execution logs (as explained with respect to FIG. 4).

At step S504, the method 500 includes predicting workload demand and resource utilization in real-time based on the set of real-time data and the set of historical data. To predict the workload demand and the resource utilization, the method 500 may include analysing, using a machine learning model 406, the set of real-time data and the set of historical data; and adapting, using the machine learning model, to dynamic changes in the set of real-time data, and the set of historical data through the facilitation of reinforcement learning technique.

For training the ML model 406, a combination of supervised learning models and reinforcement learning models may be employed. In an exemplary implementation, supervised learning models, such as LSTMs (Long Short-Term Memory networks), Random Forests, and XGBoost, are trained using the set of historical data to forecast future workload demand. The training dataset may include past workload metrics and corresponding scaling decisions, while the model validation process ensures its accuracy before deployment. Additionally, reinforcement learning may be integrated, where the ML model 406 continuously refines its decision-making process by learning from feedback provided by the cost-performance optimization module 410. This allows the ML model 406 to dynamically adjust predictions during real-time workload fluctuations.

In an exemplary embodiment, the ML model 406 may be trained using a plurality of steps. First, the set of historical data may be loaded and split into training and validation sets. The ML model 406 may be trained to recognize workload demand patterns and predict scaling needs in advance. Hyperparameters, such as learning rates and batch sizes, may be optimized using techniques like grid search and Bayesian optimization. The trained ML model 406 may then be validated against unseen workload scenarios to ensure its reliability before being deployed for real-time predictions.

To enhance accuracy over time, the ML model 406 leverages continuous learning by integrating feedback from a scaling decision engine 408. If an executed scaling decision, such as provisioning or de-provisioning virtual machines, results in inefficiencies, the ML model 406 may adapt by adjusting its future predictions.

In an exemplary implementation, in a financial services company, the system 402 may detect that trade settlement workloads experience a 60% CPU spike at 4 PM EST due to market closing activities. Based on the historical data, the ML model may predict this demand surge and instructs the scaling decision engine 408 to provision additional AWS EC2® instances five minutes before the expected peak. If the actual demand is lower than anticipated, reinforcement learning updates the model to refine future predictions, optimizing both cost and performance.

By continuously learning from the set of real-time data and refining its decision-making process, the ML model 406 may ensure efficient resource management across multiple cloud platforms.

At step S506, the method 500 includes receiving a user input from a user interface 414. The user input may be indicative of at least a user priority associated with one from among: a cost optimization and a performance optimization. User priority may refer to preferences set by users regarding the trade-off between cost optimization and performance optimization. Depending on business requirements, different users may prioritize reducing costs, ensuring high performance, or maintaining a balance between the two. When a user prioritizes cost optimization, the method 500 may include selecting cloud resources that minimize expenses while still meeting workload requirements.

In an exemplary implementation, if an organization wants to reduce cloud spending, the method 500 may opt for spot instances (AWS Spot Instances®, Microsoft Azure Low-Priority VMs®, or Google Preemptible VMs®), which offer significant cost savings but come with the risk of termination if workload demand spikes. Additionally, the method 500 may include shifting workloads to cloud regions with lower pricing or choosing instance types with lower operational costs. On the other hand, if a user wants to prioritize performance, the method 500 may ensure that workloads run on high-performance resources, even if they come at a higher cost. The method 500 may include selecting dedicated high-memory instances, GPUs for computation-heavy tasks, or low-latency cloud regions. For example, a financial trading company requiring real-time trade execution may prioritize performance over cost, ensuring that critical transactions are processed with minimal latency. To enable dynamic decision-making, the method 500 may allow users to set adjustable priorities, where the users may specify a balance between cost and performance. This is useful for workloads with fluctuating demands. For example, a media streaming company may prioritize performance during peak hours to prevent buffering but switch to cost-saving measures during off-peak times by downscaling resources.

At step S508, the method 500 includes extracting multi-cloud flexibility data from a multi-cloud orchestration module 412. The multi-cloud flexibility data may comprise at least one from among cloud resource availability data, cost and pricing data, performance and latency data, and workload distribution data (as explained in FIG. 4).

At step S510, the method 500 includes optimizing the predicted workload demand and the predicted resource utilization based on a combination of at least the user input and the multi-cloud flexibility data. The multi-cloud orchestration module 412 may extract cloud-specific data from a plurality of cloud providers like AWS®, Microsoft Azure®, and Google Cloud Platform (GCP)® to ensure workload distribution based on availability, latency, and cost factors. For example, a financial company may operate a real-time stock trading platform that processes a plurality of transactions per second. The financial company may utilize the multi-cloud orchestration module 412 to ensure low latency. The multi-cloud orchestration module 412 may monitor cloud resource availability, cost, and performance across AWS, GCP, and Azure. In an example, let's assume the multi-cloud orchestration module 412 may detect that the first cloud provider servers (e.g., AWS servers) in the New York region have the lowest latency (5 ms) but are currently operating at full capacity during peak trading hours. The second cloud provider servers (e.g., Microsoft Azure servers) in London are available but have higher latency (15 ms) for US-based transactions. The third cloud provider servers (e.g., GCP servers) in the Chicago region offer a 20% lower cost and acceptable latency (7 ms). In an exemplary implementation, the multi-cloud orchestration module 412 may detect the high AWS servers® usage and may identify GCP servers as a cost-effective alternative. The workload may be dynamically shifted to GCP servers for non-urgent transactions while keeping latency-sensitive trades on AWS servers. At step S512, the method 500 includes generating a plurality of scaling decisions 416 based on optimizing the predicted workload demand and the predicted resource utilization.

At step S514, the method 500 includes executing the plurality of scaling decisions 416. The plurality of scaling decisions 416 may be associated with resource management. The plurality of scaling decisions 416 may be associated with resource management. In an exemplary embodiment, the plurality of scaling decisions may include at least one from among provisioning, resizing, and de-provisioning of a plurality of resources across the plurality of cloud providers. In an exemplary embodiment, the plurality of scaling decisions may include at least one from among provisioning, resizing, and de-provisioning of a plurality of resources across the plurality of cloud providers. In another exemplary embodiment, the plurality of resources may include compute resources such as virtual machines, containers, and serverless computing unit that process workloads. Compute resources are responsible for executing applications, computations, and data processing tasks. In yet another exemplary embodiment, the plurality of resources may include storage resources such as block storage, object storage, databases, data warehouses and the like. In an exemplary implementation, block storage may include AWS EBS (Elastic Block Store)®, and Microsoft Azure Managed Disks®. Object storage may include AWS S3 (Simple Storage Service)®, Google Cloud Storage®, and Microsoft Azure Blob Storage®. Databases may include Google Cloud SQL®, Snowflake®, Amazon RDS®, and the like. In yet another exemplary embodiment, the plurality of resources may include network resources such as load balancers, content delivery networks, interconnect services, virtual private cloud and virtual private networks.

After step S514, the method 500 terminates.

It will be appreciated by the person skilled in the art that the disclosed method offers an intelligent solution for automating resource management.

The present disclosure provides several advantages as given below. The present disclosure provides a method and a system for automating resource management. The system provides ML-based scaling decisions by predicting workload demand in real-time using historical data. The system automatically adjusts cloud resources dynamically for optimal performance and cost efficiency. The system balances cost-performance trade-offs based on user preferences. The system seamlessly operates across multiple cloud platforms (such as AWS, Microsoft Azure, GCP).

The present invention introduces a smart cloud resource management system that leverages AI and ML algorithms to make intelligent scaling decisions. By analyzing workload patterns, job types, and real-time metrics, the system ensures efficient resource allocation while minimizing costs and maintaining high performance.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions to a non-transitory computer-readable storage medium storing instructions for automating resource management. The instructions include executable code which, when executed by a processor, may cause the processor to collect a set of real-time data, and a set of historical data from a plurality of data sources; predict workload demand and resource utilization in real-time based on the set of real-time data and the set of historical data; receiving a user input, wherein the user input is indicative of at least a user priority associated with one from among: a cost optimization and a performance optimization; receive user input, wherein the user input is indicative of at least a user priority associated with one from among: a cost optimization and a performance optimization; extract multi-cloud flexibility data from a multi-cloud orchestration module; optimizing the predicted workload demand and the predicted resource utilization based on a combination of at least the user input and the multi-cloud flexibility data; generating a plurality of scaling decisions based on optimizing the predicted workload demand and the predicted resource utilization; and executing the plurality of scaling decisions, wherein the plurality of scaling decisions are associated with resource management.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

What is claimed is:

1. A method for automating resource management, the method being implemented by at least one processor, the method comprising:
collecting, by the at least one processor, a set of real-time data and a set of historical data from a plurality of data sources;
predicting, by the at least one processor, workload demand and resource utilization in real-time based on the collected set of real-time data and the set of historical data;
receiving, by the at least one processor, a user input, wherein the user input is indicative of at least a user priority associated with at least one from among a cost optimization and a performance optimization;
extracting, by the at least one processor, multi-cloud flexibility data from a multi-cloud orchestration module;
optimizing, by the at least one processor, the predicted workload demand and the predicted resource utilization based on a combination of at least the user input and the multi-cloud flexibility data;
generating, by the at least one processor, a plurality of scaling decisions based on optimizing the predicted workload demand and the predicted resource utilization; and
executing, by the at least one processor, the plurality of scaling decisions, wherein the plurality of scaling decisions are associated with the resource management.

2. The method as claimed in claim 1, wherein the set of real-time data and the set of historical data are associated with workload metrics, wherein the workload metrics comprises metrics associated with at least one from among a CPU utilization, a memory utilization, input or output operations, a network bandwidth and a plurality of workload types.

3. The method as claimed in claim 1, wherein to predict the workload demand and the resource utilization, the method comprises:
analyzing, by the at least one processor, using a machine learning model, the set of real-time data and the set of historical data; and
adapting, by the at least one processor, using the machine learning model, to dynamic changes in the set of real-time data and the set of historical data through the facilitation of reinforcement learning technique.

4. The method as claimed in claim 1, wherein the plurality of scaling decisions comprise at least one from among provisioning, resizing and de-provisioning of a plurality of resources across a plurality of cloud providers.

5. The method as claimed in claim 1, wherein the method further comprises:
displaying at least one from among the workload metrics, the predicted workload demand, the predicted resource utilization, and the plurality of scaling decisions to the user.

6. The method as claimed in claim 5, wherein the method further comprises:
receiving a user feedback associated with the plurality of scaling decisions to refine the machine learning model.

7. The method as claimed in claim 1, wherein the multi-cloud flexibility data comprises at least one from among cloud resource availability data, cost and pricing data, performance and latency data, and workload distribution data.

8. The method as claimed in claim 1, wherein the plurality of data sources comprise at least one from among cloud infrastructure monitoring sources, and workload and job execution logs.

9. A computing device configured for automating resource management, the computing device comprising:
a processor;
a memory storing instructions; and
a communication interface coupled to each of the processor and the memory, wherein the processor is programmed to cooperate with the instructions to perform operations comprising:
collect a set of real-time data and a set of historical data from a plurality of data sources;
predict workload demand and resource utilization in real-time based on the collected set of real-time data and the set of historical data;
receive a user input, wherein the user input is indicative of at least a user priority associated with at least one from among: a cost optimization and a performance optimization;
extract multi-cloud flexibility data from a multi-cloud orchestration module;
optimize the predicted workload demand and the predicted resource utilization based on a combination of at least the user input and the multi-cloud flexibility data;
generate a plurality of scaling decisions based on optimizing the predicted workload demand and the predicted resource utilization; and
execute the plurality of scaling decisions, wherein the plurality of scaling decisions are associated with the resource management.

10. The computing device as claimed in claim 9, wherein the set of real-time data and the set of historical data are associated with workload metrics, wherein the workload metrics comprises metrics associated with at least one from among a CPU utilization, a memory utilization, input or output operations, a network bandwidth and a plurality of workload types.

11. The computing device as claimed in claim 9, wherein to predict the workload demand and the resource utilization, the operations further comprise:
analyzing, using a machine learning model, the set of real-time data and the set of historical data;
adapting, using the machine learning model, to dynamic changes in the set of real-time data, and the set of historical data through facilitation of reinforcement learning technique.

12. The computing device as claimed in claim 9, wherein the plurality of scaling decisions comprise at least one from among provisioning, resizing, and de-provisioning of a plurality of resources across a plurality of cloud providers.

13. The computing device as claimed in claim 9, wherein the operations further comprise displaying at least one from among the workload metrics, the predicted workload demand and the predicted resource utilization, and the plurality of scaling decisions to the user.

14. The computing device as claimed in claim 13, wherein the operations further comprise receiving a user feedback associated with the plurality of scaling decisions to refine the machine learning model.

15. The computing device as claimed in claim 9, wherein the multi-cloud flexibility data comprises at least one from among: cloud resource availability data, cost and pricing data, performance and latency data, and workload distribution data.

16. The computing device as claimed in claim 9, wherein the plurality of data sources comprise at least one from among cloud infrastructure monitoring sources, and workload and job execution logs.

17. A non-transitory computer readable storage medium storing instruction for automating resource management, the instructions comprising executable code which when executed by a processor, causes the processor to perform operations comprising:
collecting, a set of real-time data and a set of historical data from a plurality of data sources;
predicting, workload demand and resource utilization in real-time based on the collected set of real-time data and the set of historical data;
receiving, a user input, wherein the user input is indicative of at least a user priority associated with at least one from among a cost optimization and a performance optimization;
extracting, multi-cloud flexibility data from a multi-cloud orchestration module;
optimizing, the predicted workload demand and the predicted resource utilization based on a combination of at least the user input and the multi-cloud flexibility data;
generating, by the at least one processor, a plurality of scaling decisions based on optimizing the predicted workload demand and the predicted resource utilization; and
executing, by the at least one processor, the plurality of scaling decisions, wherein the plurality of scaling decisions are associated with the resource management.

18. The non-transitory computer readable storage medium as claimed in claim 17, wherein the set of real-time data and the set of historical data are associated with workload metrics, wherein the workload metrics comprises metrics associated with at least one from among a CPU utilization, a memory utilization, input or output operations, a network bandwidth and a plurality of workload types.

19. The non-transitory computer readable storage medium as claimed in claim 17, wherein to predict the workload demand and the resource utilization, the operations comprise:
analyzing, by the at least one processor, using a machine learning model, the set of real-time data and the set of historical data; and
adapting, by the at least one processor, using the machine learning model, to dynamic changes in the set of real-time data and the set of historical data through the facilitation of reinforcement learning technique.

20. The non-transitory computer readable storage medium as claimed in claim 17, wherein the plurality of scaling decisions comprise at least one from among provisioning, resizing and de-provisioning of a plurality of resources across a plurality of cloud providers.
